(19) United States
(12) Patent Application Publication
(10) Pub. No.: US 2011/0156623 A1
(43) Pub. Date: Jun. 30, 2011

(54) MOTOR DRIVE APPARATUS AND POWER STEERING APPARATUS USING THE SAME

(75) Inventors: Kouichi Nakamura, Kariya-city (JP); Yasuhiko Mukai, Kariya-city (JP); Nobuhiko Uryu, Kariya-city (JP)

(73) Assignee: DENSO CORPORATION, Kariya-city (JP)

(21) Appl. No.: 12/977,580

(22) Filed: Dec. 23, 2010

(30) Foreign Application Priority Data
Dec. 25, 2009 (JP) 2009-295532
Nov. 5, 2010 (JP) 2010-248158

(51) Int. Cl. H02P 21/00

(52) U.S. Cl. 318/400.02

(57) ABSTRACT

In a motor drive apparatus having two power supply systems for a motor, output phase currents supplied from inverters and detected by current sensors are added. Sums of the phase currents are fed back to a 3-2 phase conversion section and converted into a d-axis current and a q-axis current. A 2-3 phase conversion section outputs the same three-phase voltage command values to the inverters. Thus, the 3-2 phase conversion section and the 2-3 phase conversion section are both reduced to 1 in number, which is less than 2 of the inverters.

### CROSS REFERENCE TO RELATED APPLICATION

This application is based on and incorporates herein by reference Japanese patent applications No. 2009-295532 filed on Dec. 25, 2009 and No. 2010-248158 filed on Nov. 5, 2010.

### FIELD OF THE INVENTION

The present invention relates to a motor drive apparatus, which drives a multi-phase electric motor by a plurality of inverters, and an electric power steering apparatus using the same.

### BACKGROUND OF THE INVENTION

For reducing a product size and increasing output power of a motor drive apparatus, it is proposed to arrange switching elements in series and in parallel and to provide a multiple inverters for a multiple power supply systems. In some products such as a vehicular motor device, in which an electric motor is used, it is required to continuously maintain operation of the motor even when a failure occurs in the motor. Multiple winding sets of the motor, parallel and series connection of the switching elements and a multiple power supply systems including a multiple inverters are used for meeting such requirements. In case of a power steering system for a vehicle, for example, even slight vibration of a motor is transferred directly to a driver. Therefore, such a motor is required to have high precision and high speed response characteristic.

The following patent document 1 discloses an AC motor control apparatus, which is configured to reduce imbalance of currents supplied to a multi-phase AC motor.
Patent document 1: JP 2614788 (JP H04-325898A)

According to the technology of patent document 1, it is required to provide the same number of coordinate conversion sections and command coordinate conversion sections, which perform calculation associated with a rotational coordinate, as the number of inverters. The calculation associated with the rotational coordinate usually uses trigonometric functions. A microcomputer provided for such calculation processing is heavily loaded with arithmetic calculation processing. Thus, a high performance and high cost microcomputer need be used to form a multi-system motor drive apparatus.

### SUMMARY OF THE INVENTION

It is therefore an object of the present invention to provide a multi-system motor drive apparatus in low cost.

According to the present invention, a motor drive apparatus is provided for driving a three-phase AC motor by DC power of a DC power source. The motor drive apparatus comprises a plurality of inverters, a phase current detection section, a 3-2 phase conversion section, a current control calculation section and a 2-3 phase conversion section. The inverters convert the DC power of the DC power source into AC power and supply the AC power to the three-phase AC motor. The phase current detection section detects three-phase currents supplied from the plurality of inverters to the three-phase AC motor. The 3-2 phase conversion section converts phase current detection values of each phase detected by the phase current detection section into a d-axis current and a q-axis current. The current control calculation section generates representative two-phase voltage command values based on detection values of the d-axis current and the q-axis current outputted from the 3-2 phase current conversion section and command values of the d-axis current and the q-axis current. The 2-3 phase conversion section generates three-phase voltage command values from the representative two-phase voltage command values. The numbers of the 3-2 phase conversion section and the 2-3 phase conversion section are less than that of the inverters.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic illustration of an electric power steering apparatus, to which a motor drive apparatus according to the present invention is applied;

FIG. 2 is a block diagram of the electric power steering apparatus, to which the motor drive apparatus according to the present invention is applied;

FIG. 3 is a circuit diagram of a part of the motor drive apparatus, which has two power supply systems;

FIG. 4 is a schematic illustration of a first example of the motor drive apparatus;

FIG. 5 is a schematic illustration of a second example of the motor drive apparatus;

FIG. 6 is a schematic illustration of a third example of the motor drive apparatus; and

FIG. 7 is a schematic illustration of a fourth example of the motor drive apparatus.

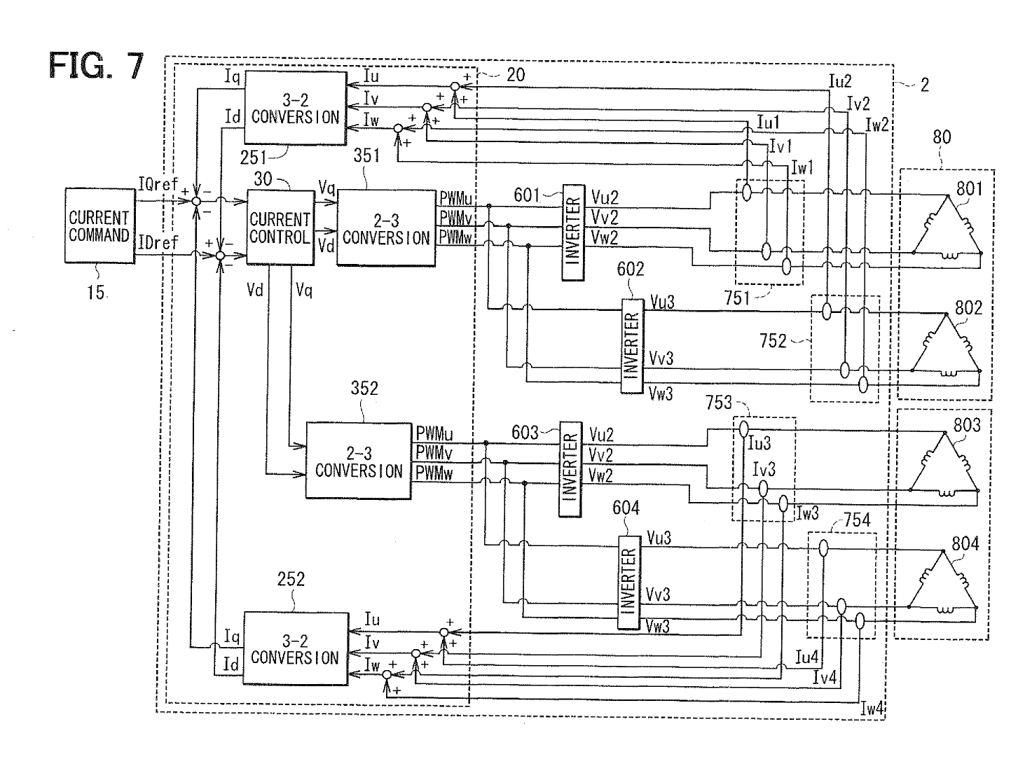

### DETAILED DESCRIPTION OF THE PREFERRED EMBODIMENT

The present invention will be described in detail with reference to the accompanying drawings.

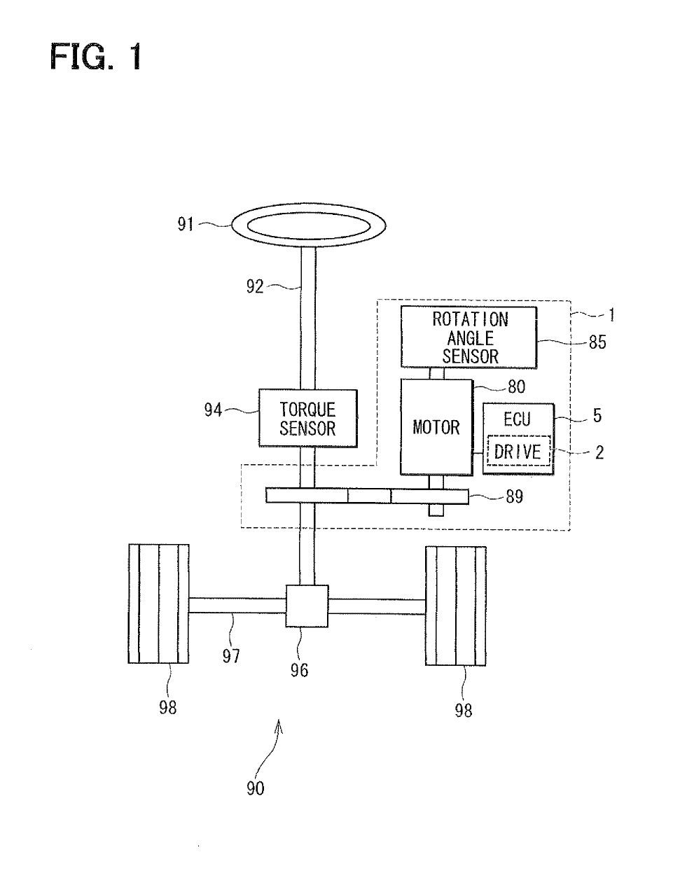

As shown in FIG. 1, a motor drive apparatus according to the present invention is applied to an electric motor-driven power steering apparatus 1, which assists steering operation of a vehicular steering apparatus 90.

In the steering apparatus 90, a torque sensor 94 is attached to a steering shaft 92, which is coupled to a steering wheel 91 for detecting a steering torque. A pinion gear 96 is provided on the top end of the steering shaft 92 and in engagement with a rack shaft 97. A pair of wheels 98 is coupled to both ends of the rack shaft 97 through tie rods, etc. The wheels 98 are rotatable. The rotary motion of the steering shaft 92 is translated to a linear motion of the rack shaft 97. The pair of tire wheels 98 is steered by an angle, which corresponds to a change in the linear motion of the rack shaft 97.

The electric power steering apparatus 1 includes an electronic control unit (ECU) 5, a motor 80 for generating steering assist torque, a rotation angle sensor 85 for detecting the angular position of the motor 80, and a reduction gear 89 for transferring the torque of the motor 80 to the steering shaft 92 by speed-reducing the rotation of the motor 80. The ECU 5 includes a motor drive apparatus 2, which controls drive of the motor 80. The motor 80 is a three-phase brushless motor and configured to rotate the reduction gear 89 in the forward or rearward direction. With this configuration, the electric power steering apparatus 1 generates the steering assist torque and transfers it to the steering shaft 92 thereby to power-assist steering of the steering wheel 91.

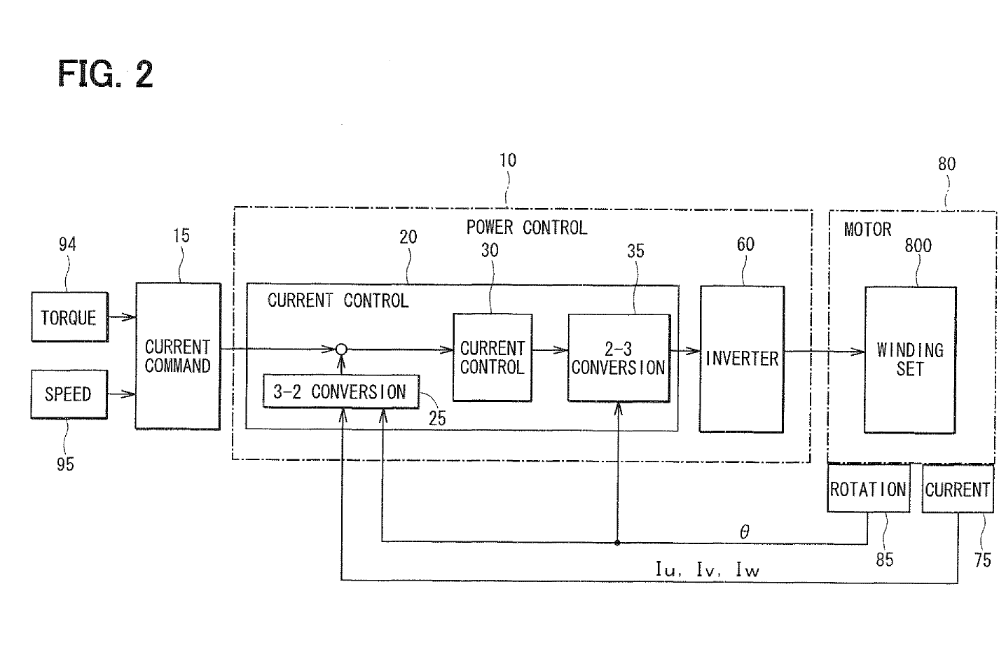

As shown in FIG. 1, the motor 80 is coupled directly to the steering wheel 91 and hence vibration of the motor 80 is transferred directly to hands of a vehicle driver. It is therefore required in a control block diagram of the electric power steering apparatus shown in FIG. 2 that processing from current command value calculation to current control calculation. These calculations are executed at a high speed of 500 μsec.

The electric power steering apparatus 1 is configured functionally as shown in FIG. 2. In FIG. 2, the configuration for normal operation is shown and configuration for failure determination, which will be described later, is not shown. A detection value of the steering torque detected by the torque sensor 94 and a detection value of the vehicle speed detected by a vehicle speed sensor 95 are inputted to a current command value calculation unit 15. The current command value calculation unit 15 outputs the command value to a current control unit 20, which is a d-q control section.

The current control unit 20 includes a three-phase to two-phase (3-2) phase conversion section 25, a current control calculation section 30, and a two-phase to three-phase (2-3) phase conversion section 35. The 3-2 phase conversion section 25 is a d-q-axis current conversion section. The current control calculation section 30 may be a proportional (P) control calculation section, a proportional-and-integral (PI) control calculation section or a proportional-integral-derivative (PID) control calculation section.

The 3-2 phase conversion section 25 converts the phase current detection values Iu, Iv and Iw detected by a current sensor 75 to a d-axis current and a q-axis current based on the electric angle θ of the motor, which is detected by the rotation angle sensor 85 and fed back. The d-axis current is parallel to a direction of magnetic flux. The q-axis current is orthogonal to the direction of the magnetic flux. The d-axis current is referred to as an excitation current or a field current. The q-axis current is referred to a torque current. The d-axis current and the q-axis current outputted from the 3-2 phase conversion section 25 are fed back to the command values produced from the current command value calculation unit 15. The current control calculation section 30 calculates an output value by performing a proportional-integral control on a difference between the command value and the detection value. The two-phase voltage command values outputted from the current control calculation section 30 are converted into three-phase (U-phase, V-phase, W-phase) voltage command values by the 2-3 phase conversion section 35 and outputted to an inverter 60. The motor electric angle 8 detected by the rotation angle sensor 85 is also fed back to the 2-3 phase conversion section 35. The current control unit 20 may be implemented by a microcomputer.

Alternating current (AC) electric power generated by the inverter 60 is supplied to a winding set 800 of the motor 80. The current sensor 75 detects an output current of the inverter 60 phase by phase. The rotation angle sensor 85 detects the motor electric angle θ. The current control unit 20 and the inverter 60 form an electric power control device 10. The power control unit 10 and the current sensor 75 form the motor drive apparatus 2.

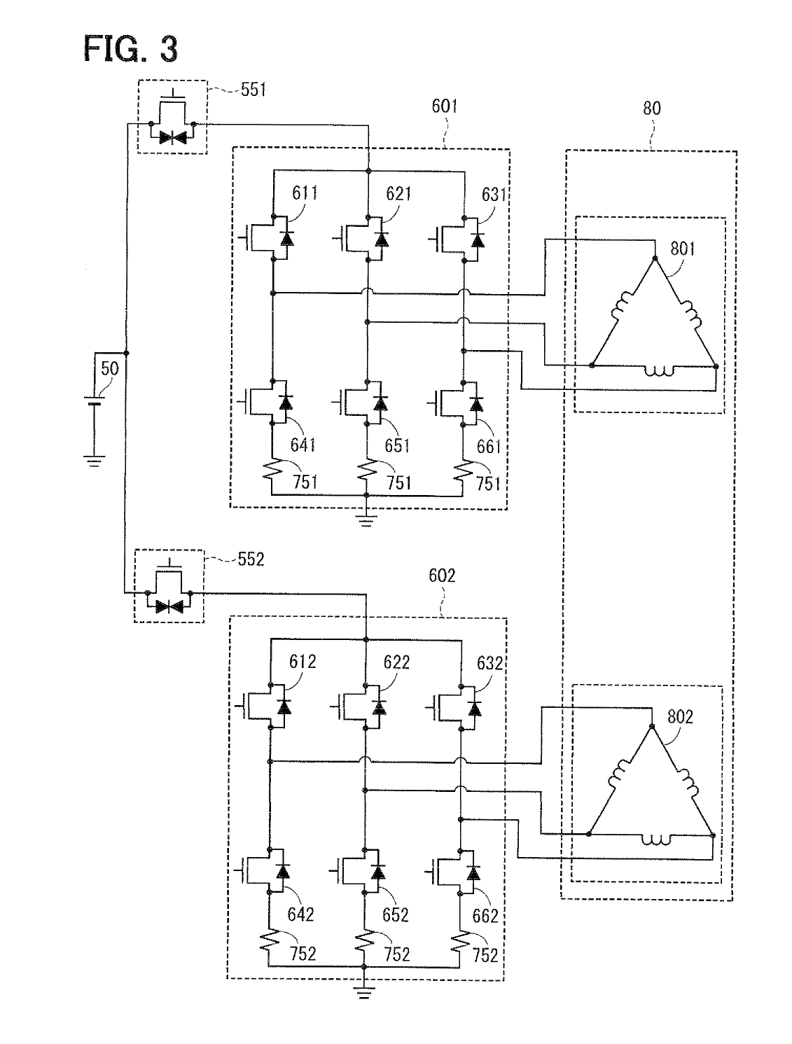

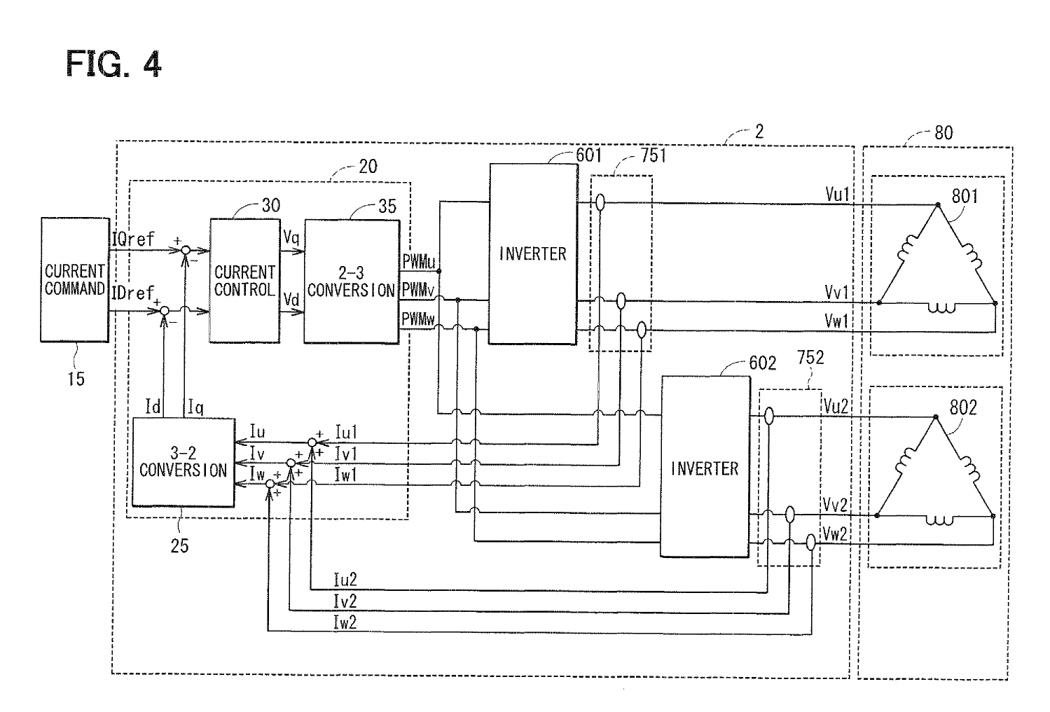

As exemplarily shown in FIG. 3, the motor 80 has a plurality of (for example, two) winding sets 801 and 802, and the motor drive apparatus 2 also has the same number of sets of inverters 601, 602 and the like. A DC power source 50 is connected to both of a first power supply system (top part in FIG. 3) and a second power supply system (bottom part in FIG. 3). The first power supply system is formed by a first power relay 551, a first inverter 601 and a first motor winding set 801. The second power supply system is formed by a second power relay 552, a second inverter 602 and a second motor winding set 802. The power relays 551 and 552 conduct or interrupt the electric DC power of the battery 50 to the inverters 601 and 602, respectively, as power conduction/interruption sections. The inverters 601 and 602 generate electric three-phase AC power from the DC power. The motor winding sets 801 and 802 are arranged symmetrically in the motor 80 so that the motor 80 may be driven by the three-phase AC power of the inverters 601 and 692. The motor windings sets 801 and 802 are connected in a Δ-shape in this example. The motor winding sets 801 and 802 may alternatively be connected in a V-shape. The current sensor 75 includes, as shown in FIG. 4, two current sensors 751 and 752 to detect output currents of the inverters 601 and 602, respectively, with respect to each phase.

Each of the inverters 601 and 602 has six switching elements. Each of the switching elements is a MOS field effect transistors (FET) and referred to simply as a FET. The FETs at the power source side (high potential side) and the ground side (low potential side) are referred to as a high FET and a low FET, respectively. The six switching elements of the first inverter 601 are a U-phase high FET 611, a V-phase high FET 621, a W-phase high FET 631, a U-phase low FET 641, a V-phase low FET 651 and a W-phase low FET 661. The six switching elements of the second inverter 602 are a U-phase high FET 612, a V-phase high FET 622, a W-phase high FET 632, a U-phase low FET 642, a V-phase low FET 652 and a W-phase low FET 662.

If the motor 80 has more winding sets, more power relays and inverters are provided in parallel to two power relays 551, 552 and two inverters 601, 602. A plurality of power supply systems, each including a winding set and an inverter, is provided so that the motor 80 may continue to operate with operative power supply systems even when one power supply system becomes inoperative, that is, one power supply system is abnormal and in failure.

According to the present embodiment, the motor drive apparatus 2 is assumed to have two power supply systems as shown in FIG. 4 as a first example. Therefore, the inverter 60 includes two inverters 601 and 602. The function of each power supply system is generally similar to that described with reference to the power control unit 10 of FIG. 2. The current command value calculation unit 15 outputs a d-axis current command value IDref and a q-axis current command value IQref. The current control calculation section 30 generates the representative two-phase voltage command values Vd and Vq based on the d-axis current Id and the q-axis current Iq outputted from the 3-2 phase conversion section 25 and the d-axis current command value IDref and the q-axis current command value IQref. The 2-3 phase conversion section 35 generates three-phase voltage command values PWMu, PWMv and PWMw from two-phase voltage command values Vd and Vq, and outputs such three voltage command values to the inverters 601 and 602. The first inverter 601 supplies the three-phase AC voltages Vu1, Vv1 and Vw1 to the first motor winding set 801. The second inverter 602 supplies the three-phase AC voltages Vu2, Vv2 and Vw2 to the second motor winding set 802.

The current sensor 751 is provided to detect output currents of the first inverter 601 and outputs phase current detection values Iu1, Iv1 and Iw1. The current sensor 752 is provided to detect output currents of the second inverter 602 and outputs phase current detection values Iu2, Iv2 and Iw2. These phase current detection values are added phase by phase. Sums Iu, Iv and Iw of the detected output currents are fed back to the 3-2 phase conversion section 25 to be converted into two currents Id and Iq. Therefore only one 3-2 phase conversion section 25 is needed, while two inverters 601 and 602 are needed. Since there is only one 3-2 phase conversion section 25, only one set of the d-axis current Id and the q-axis current Iq is needed after the 3-2 phase conversion. As a result, only one current control calculation section 30 and only one 2-3 phase conversion section 35 are needed to perform respective processing on the set of currents Id and Iq. That is, only one current control unit 20 is needed.

The 2-3 phase conversion section 35 outputs to two inverters 601 and 602 the same three-phase voltage command values PWMu, PWMv and PWMw. Thus, the number of the 2-3 phase conversion section 35 is reduced to one, which is less than two of the inverters 601 and 602.

The motor drive apparatus 2 may have as many as N power supply systems. N is an integer, which is equal to or greater than 3. The number of inverters 60 is N. The current sensor 75 in each of the first to the N-th power supply systems detects the output current of the inverter 60 and outputs the phase current detection values Iu1, Iv1 and Iw1 to IuN, IvN and IwN. The phase current detection values of as many as 3×N are added with respect to each phase. The sums Iu, Iv and Iw of as many as N output currents of respective phases are fed back to the 3-2 phase conversion section 25 are converted into two currents Id and Iq. In this case, the number of the 3-2 phase conversion section 25 is one and less than the number N of the inverters 60.

If only one 3-2 phase conversion section 25 and only one 2-3 phase conversion section 35 are provided in the motor drive apparatus 2, the 2-3 phase conversion section 35 outputs the same three-phase voltage command values PWMu, PWMv and PWMw to as many as N inverters 60. The number of the 2-3 phase conversion section 35 is 1 and less than N of the inverters 60.

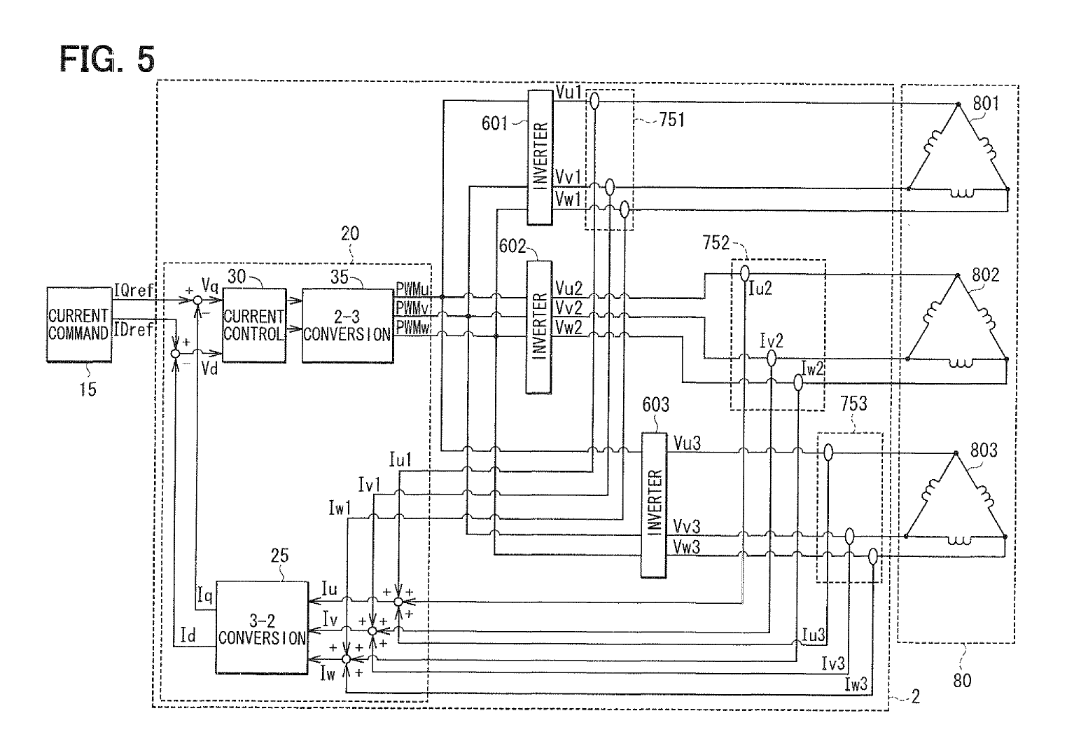

The motor drive apparatus 2 is assumed to have three systems (N=3) as shown in FIG. 5 as a second example. The current control unit 20 includes one 3-2 phase conversion section 25 and one 2-3 phase conversion section 35. The 2-3 phase conversion section 35 outputs the three-phase voltage command values PWMu, PWMv and PWMw to the first, second and third inverters 601, 602 and 603 of the three power supply systems for the first, second and third motor winding sets 801, 802 and 803, respectively.

In the example of the N power supply systems, the N systems may be divided into a plurality of groups and the phase current detection values may be added group by group. For example, the N systems may be divided into as many as M groups. M is less than N. The sum of the phase currents of each group is fed back to corresponding one of as many as M 3-2 phase conversion sections 25. As a result, as many as M sums are converted into as many as M sets of d-axis current and q-axis current, respectively. In this case, the number of the 3-2 phase current conversion sections 25 is M and less than the number N of the inverters 60.

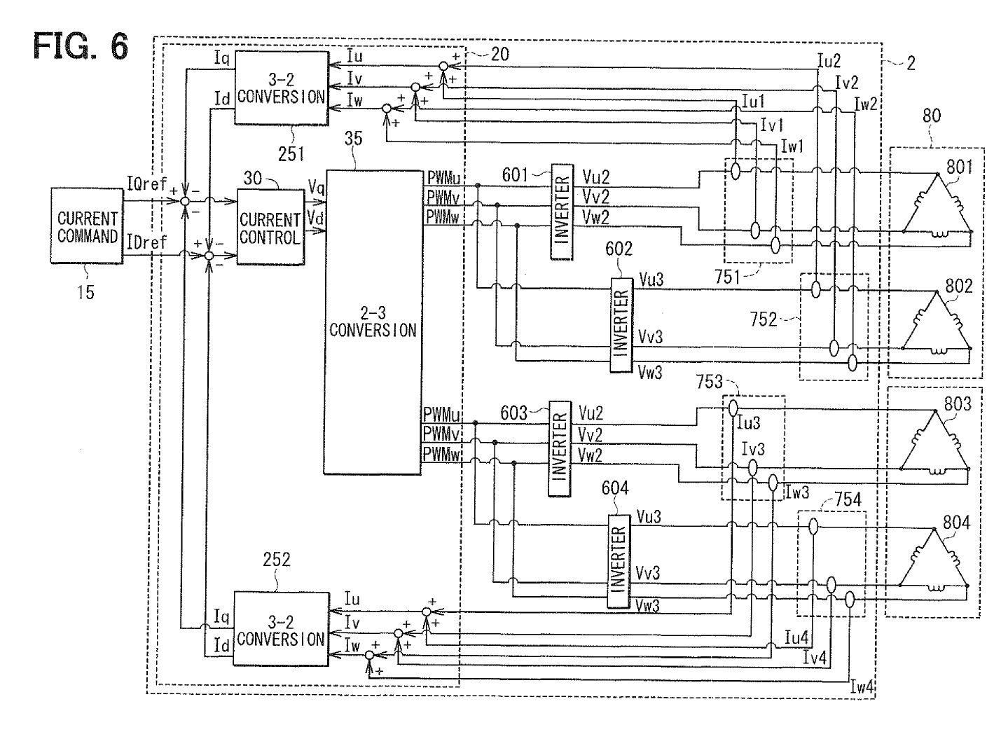

The motor drive apparatus 2 is assumed to have four power supply systems (N=4), in which two 3-2 phase conversion sections 251, 252 are provided (M=2), as shown in FIG. 6 as a third example. That is, the first and second inverters 601 and 602 are grouped into one group, and the third and fourth inverters 603 and 604 are grouped into the other group. The current control unit 20 includes two 3-2 phase conversion sections 251, 252 and one 2-3 phase conversion section 35. The 2-3 phase conversion section 35 outputs the three-phase voltage command values PWMu, PWMv and PWMw to the inverters 601, 602, 603 and 604 of the four power supply systems. The inverters 601, 602, 603 and 604 supply three-phase AC voltages Vu, Vv and Vw to each of the motor winding sets 801, 802, 803 and 804,

The motor drive apparatus 2 is assumed to have four power supply systems (N=4), in which two 3-2 phase conversion sections 251, 252 and two 3-2 phase conversion sections 351, 352 are provided (M=2), as shown in FIG. 6 as a fourth example. That is, the first and second inverters 601 and 602 are grouped into one group, and the third and fourth inverters 603 and 604 are grouped into the other group. The 2-3 phase conversion sections 351 outputs one set of the three-phase voltage command values PWMu, PWMv and PWMw to the inverters 601 and 602. The 2-3 phase conversion sections 352 outputs the other set of the three-phase voltage command values PWMu, PWMv and PWMw to the inverters 603 and 604.

This apparatus is particularly of advantage in that the current control unit 20 requires less number of the 3-2 phase conversion sections 25 and the 2-3 phase conversion sections 35 than that of the inverters 60. The microcomputer is loaded with less arithmetic operation and. As a result, the electric power steering apparatus, which requires high speed arithmetic operation, can be provided in low costs.

The present invention is not limited to the disclosed embodiment but may be implemented in different ways.

What is claimed is:

1. A motor drive apparatus for driving a three-phase AC motor by DC power of a DC power source, the motor drive apparatus comprising:
a plurality of inverters for converting the DC power of the DC power source into AC power and supplying the AC power to the three-phase AC motor;
a phase current detection section configured to detect three-phase currents supplied from the plurality of inverters to the three-phase AC motor;
a 3-2 phase conversion section configured to convert phase current detection values of each phase detected by the phase current detection section into a d-axis current and a q-axis current;
a current control calculation section configured to generate representative two-phase voltage command values based on detection values of the d-axis current and the q-axis current outputted from the 3-2 phase current conversion section and command values of the d-axis current and the q-axis current; and
a 2-3 phase conversion section configured to generate three-phase voltage command values from the representative two-phase voltage command values,
wherein numbers of the 3-2 phase conversion section and the 2-3 phase conversion section are less than that of the inverters.

2. The motor drive apparatus according to claim 1, wherein:
the 3-2 phase conversion section is configured to convert a sum of a plurality of phase current detection values of the plurality of inverters.

3. The motor drive apparatus according to claim 1, wherein:
the 2-3 phase conversion section is configured to apply the three-phase voltage command values to the plurality of inverters.

4. The motor drive apparatus according to claim 4, wherein:
the three-phase AC motor is provided in an electric power steering apparatus.
